(19) United States
(12) Patent Application Publication
(10) Pub. No.: US 2026/0348770 A1
(43) Pub. Date: Nov. 5, 2026

(54) ELECTRIC CIRCUIT FOR MONITORING THE RESPECTIVE TEMPERATURE OF A PLURALITY OF CHARGING CONTACTS OF A CHARGING PLUG CONNECTOR

(71) Applicant: Kiekert Aktiengesellschaft, Heiligenhaus (DE)

(72) Inventors: Michael BERRES, Köln (DE); Ingo NÖVERMANN, Mülheim an der Ruhr (DE)

(73) Assignee: Kiekert Aktiengesellschaft, Heiligenhaus (DE)

(21) Appl. No.: 19/106,439

(22) PCT Filed: Aug. 8, 2023
(86) PCT No.: PCT/DE2023/100581

§ 371 Date: Feb. 25, 2025

(30) Foreign Application Priority Data
Sep. 1, 2022 (DE) 10 2022 122 165.2

(51) Int. Cl. G01K 7/22; B60L 53/16; G01K 1/02; H01R 13/66; H02J 7/80

(52) U.S. Cl. CPC G01K 7/22; B60L 53/16; G01K 1/026; H02J 7/80; H01R 13/6683; H01R 2201/26

(57) ABSTRACT

The invention relates to an electric circuit (1) for monitoring the corresponding temperature of a plurality of charging contacts (2) of a charging plug connector (3) for an electric or hybrid vehicle, comprising a plurality of temperature-based resistors (4), each of which is paired with a charging contact (2) and can be thermally coupled thereto, and a plurality of constant resistors (5), each of which has a constant resistance, wherein each of the temperature-based resistors (4) is connected to one of the constant resistors (5) in series; a parallel circuit is provided, according to which the series circuits consisting of a corresponding temperature-based resistor (4) and a corresponding constant resistor (5) are connected together in parallel; all of the constant resistors (5) have different resistances; and a voltage measuring device (6) is provided, by means of which the voltage dropping across the parallel circuit can be determined. The invention thus allows a simple and reliable manner for determining which charging contact of a plurality of charging contacts of a charging plug connector for an electric or hybrid vehicle is exhibiting a critical heating during operation.

The invention relates to an electric circuit for monitoring the corresponding temperature of a plurality of charging contacts of a charging plug connector for an electric or hybrid vehicle, comprising a plurality of temperature-based resistors, each of which is paired with a charging contact and can be thermally coupled thereto.

Electric and hybrid vehicles have a rechargeable energy storage device, usually a high-voltage battery, which provides energy to an electric drive motor during driving operation. The storage capacities of these high-voltage batteries are limited, so they must be regularly recharged at a charging station. The battery is charged via a charging cable provided between the charging station and the vehicle, wherein the charging cable is provided on one side with a charging plug that can be plugged into a charging socket provided on the charging station, and on the other side with a charging coupling that can be connected to a built-in charging plug installed in the electric and hybrid vehicle, for example in accordance with the European standard IEC 62196 Type 2. In the present case, charging sockets, charging plugs, charging couplings and built-in charging plugs are subsumed under the term “charging plug connector.” Charging sockets and charging couplings have contact sleeves as charging contacts, and charging plugs as well as built-in charging plugs that can be installed in electric or hybrid vehicles have contact pins as charging contacts that can be inserted into the contact sleeves.

Charging plug connectors for electric and hybrid vehicles are subject to legal and user-specific requirements regarding the temperature monitoring of AC and DC charging contacts. For DC charging, a temperature measurement is usually required on both DC charging contacts. For this purpose, a component suitable for temperature measurement, usually an NTC resistor, is brought as close as possible to the heat source, i.e., the charging contact, in order to enable real-time temperature monitoring for charging optimization and safety monitoring. An NTC resistor is a resistor that is used in electronic components. It is also called a thermistor or hot conductor. The abbreviation “NTC” stands for “negative temperature coefficient” and describes the property of thermistors to conduct electricity better as the temperature increases because they have a negative temperature coefficient.

For AC charging, either an NTC temperature measurement or a simpler PTC temperature monitoring is usually required. A PTC resistor, also known as a thermistor or PTC thermistor (“positive temperature coefficient”), is also a temperature-based resistor, but it conducts electrical current better at low temperatures than at high temperatures.

The difference between using a PTC element and an NTC element is that an NTC element enables real temperature measurement, while a PTC element usually has a non-linear resistance behavior above a threshold temperature and can therefore be used to signal when a critical temperature has been exceeded. PTC elements can thus be used to implement a type of “safety” by returning a rapidly changing value to a reading system when the critical temperature has been exceeded.

Depending on the standard and manufacturer specification, a real temperature measurement or only a detection of the exceedance of a temperature threshold is required. This may be required either for all AC charging contacts (e.g., L1, L2, L3 and N for connectors according to the European standard IEC 62196 Type 2) separately for each AC charging contact or bundled, i.e., for all AC charging contacts together.

DE 102015 106251 A1 describes a temperature monitoring device with a carrier element extending flatly along a plane and having an opening. The carrier element can be designed as a circuit board. The contact elements are components of a contact assembly that can be attached to a plug insert as a modular unit. The contact assembly has a temperature monitoring device with a carrier element. The temperature monitoring device serves to detect any impermissible heating on at least those contact elements which are used to transmit large currents during operation of the plug connector part. For the necessary contacting, the carrier element has a metal coating at each of the openings to provide a contact surface in the form of a through-hole. A sensor device 432 is arranged on the coupling portion, which conducts the heat of the contact element to the sensor device. From the sensor device, conductor tracks lead to a higher-level control device. The sensor signals generated by the sensor device can be evaluated at the control device in order to control the currents flowing through the contact elements depending on the sensor signals. The sensor device can be provided for each contact element to be monitored, so that the temperature at the individual contact elements to be monitored can be individually monitored and heating can be detected.

WO 2021/004765 A1 describes an electrical assembly with a temperature monitoring device. What is described is a plug connector part with both AC charging contacts and DC charging contacts. To monitor possible heating, in particular at the DC charging contacts, the plug connector part has an electrical assembly. This assembly consists of contact elements that are arranged on a carrier element and electrically connected to paired load lines. Each contact element is accommodated in a paired receiving opening of the carrier element. A temperature monitoring device has a temperature sensor. The temperature monitoring device is fixed to the surface of the carrier element. The heat of the contact element is conducted to the temperature monitoring device.

Based on this, the object of the invention is a simple and reliable manner for determining which charging contact of a plurality of charging contacts of a charging plug connector for an electric or hybrid vehicle is exhibiting a critical heating during operation.

This object is achieved by the subjects of the independent claims. Preferred developments of the invention are described in the dependent claims.

According to the invention, an electric circuit is thus provided for monitoring the corresponding temperature of a plurality of charging contacts of a charging plug connector for an electric or hybrid vehicle, comprising a plurality of temperature-based resistors, each of which is paired with a charging contact and can be thermally coupled thereto, and a plurality of constant resistors each of which has a constant resistance, wherein each of the temperature-based resistors is connected to one of the constant resistors, a parallel circuit is provided, according to which the interconnections consisting of a corresponding temperature-based resistor and a corresponding constant resistor are connected together in parallel, all of the constant resistors have different resistances and a voltage measuring device is provided, by means of which the voltage dropping across the parallel circuit can be determined.

According to a preferred development of the invention, this electric circuit is implemented in such a way that a plurality of temperature-based resistors, each of which is paired with a charging contact and can be thermally coupled thereto, and a plurality of constant resistors, each of which has a constant resistance, are provided, wherein each of the temperature-based resistors is connected to one of the constant resistors in series, a parallel circuit is provided, according to which the series circuits consisting of a corresponding temperature-based resistor and a corresponding constant resistor are connected together in parallel, all of the constant resistors have different resistances and a voltage measuring device is provided, by means of which the voltage dropping across the parallel circuit can be determined.

It is therefore a substantial aspect of this embodiment to “code” the electrical path via a corresponding temperature-based resistor, namely by means of a constant resistor of which the resistance is different from the resistances of all other constant resistors arranged in the path of other temperature-based resistors. For each charging contact of which the temperature is to be monitored, there is a series circuit of a temperature-based resistor and a constant resistor, wherein the temperature-based resistor is intended to detect the temperature of the corresponding charging contact. These series circuits are connected together in parallel, so that the total resistance of this parallel circuit changes individually depending on which of the temperature-based resistors shows an increased resistance because the charging contact to which it is assigned has heated up beyond a critical temperature.

An alternative implementation of the invention is carried out according to a preferred development of the invention in such a way that the electric circuit according to the invention is additionally provided with a plurality of transistors, wherein such interconnections are provided according to which a temperature-based resistor is connected to the base of a corresponding transistor and the constant resistors are connected in series with a corresponding transistor via its two other terminals and a parallel circuit is provided according to which the interconnections each consisting of a constant resistor, a transistor and a temperature-based resistor are connected together in parallel.

According to this preferred embodiment of the invention, a transistor is used for each charging contact and is pre-controlled at its corresponding base via a circuit with a temperature-based resistor. The temperature-based resistor is preferably a PTC element or an NTC element. If it is a PTC element, the PTC element becomes highly resistive when a predefined limit temperature is reached at the charging contact, which causes a voltage drop at the transistor base, so that the transistor blocks. If an NTC element is used, when the limit temperature at the charging contact is reached, the NTC element becomes low-resistance, which causes a voltage increase at the transistor base, causing the transistor to switch on. A “coding” of the electrical paths is achieved here by the constant resistance of the corresponding electrical path being “switched on” or “switched off” by means of the transistor.

The preferred developments of the invention described below apply to the invention in general and thus also to the two alternatives mentioned above.

Preferably, the temperature-based resistors are all of the same type and show the same dependence of their resistance on temperature. In this preferred embodiment of the invention, it is advantageous that it is not necessary to ensure that the corresponding resistances of the temperature-based resistor and the constant resistor always match each other in such a way that an individual resistance is achieved overall, which enables the function according to the invention that, by means of the total resistance of the parallel circuit, a conclusion can be drawn about the temperature-based resistor that is located on the charging contact of which the temperature has exceeded a critical temperature.

In principle, different temperature-based resistors can be used within the scope of the invention. However, as already mentioned above, according to a preferred embodiment of the invention, the temperature-based resistors are PTC elements or NTC elements. The resistance curve of a PTC element is usually non-linear and can, for example, be in the range of 618 to 1350Ω in a temperature range of −40 °C to 90 °C. Above 90 °C, the resistance increases rapidly and significantly, so that at 100 °C it is already at approximately 10000Ω. Above 90 °C/1350Ω, there is a trigger threshold that can be used to detect a critical temperature.

The invention initially only requires that all of the constant resistors have different resistances. However, the detection of the temperature-based resistance, which has detected a critical temperature increase, via the total resistance of the parallel circuit works particularly reliably if the resistance of the constant resistor with the second lowest resistance is at least twice as high as the resistance of the constant resistor with the lowest resistance. Preferably, the corresponding difference between the resistances of all constant resistors corresponds at least to the difference between the resistance of the constant resistor with the second lowest resistance and the resistance of the constant resistor with the lowest resistance. In other words, this means that the difference in the resistances of any two constant resistors is at least as large as the difference between the resistance of the constant resistor with the second lowest resistance and the resistance of the constant resistor with the lowest resistance.

In this context, it is very particularly preferred that, with the exception of the constant resistor with the lowest resistance, the resistance of each constant resistor is at least twice the resistance of the constant resistor with the next smallest resistance. This means that the differences between the resistances become greater the larger the resistances themselves are. A preferred embodiment in this context is that the resistances of the constant resistors follow the law of a diverging geometric series. The calculation of the resistances for n constant resistors is possible, for example, by means of the following formula:

$${R}_{1} {\sum }_{k = 0}^{n} {q}^{k} = \{ {R}_{1} , ... , {R}_{n} \}$$

wherein
R₁ constitutes the resistances of the constant resistor with the lowest resistance,
Rₙ constitutes the resistances of the constant resistor with the largest resistance and
q is any value greater than 1.

In this context, it is very particularly preferred that q is greater than or equal to 2.

The invention further relates to an electric circuit board for installation in a charging plug connector for an electric or hybrid vehicle, with an electric circuit as described above.

According to a preferred development of the invention, the electric circuit board is designed such that the temperature-based resistors are arranged at thermal contact points of the electric circuit board for thermally contacting a corresponding charging contact of the charging plug connector and the thermal contact points are provided with thermal contact elements which are in direct thermal contact with a corresponding temperature-based resistor and with which the charging contacts can be physically contacted. Such an electric circuit board can be arranged in a charging plug connector in such a way that it is located “between” the charging contacts, so to speak, and its thermal contact elements come into direct thermal contact with the charging contacts. In this way, the thermal contact elements are substantially in thermal equilibrium with the charging contacts, so that the temperature-based resistors can detect the temperature prevailing at a corresponding charging contact almost in real time.

In this context, it is very particularly preferred that the thermal contact points are formed by recesses in the electric circuit board, preferably by part-circular recesses. Such part-circular recesses can nestle directly against circular charging contacts and thus ensure very good heat transfer.

The invention further relates to a charging plug connector for an electric or hybrid vehicle with an electric circuit as described above or with an electric circuit board as described above. It is very particularly preferred that the temperature-based resistors are arranged in such a way that they can be used to detect the corresponding temperature of an AC charging contact. Often, more than two AC contacts are provided in such a charging plug connector, so that in this way, namely with the electric circuit described above, the current temperature can be detected individually at each AC charging contact in an efficient manner. The charging plug connector is preferably a built-in charging plug that can be installed in the body of an electric or hybrid vehicle. For example, this is a built-in charging plug that complies with the European standard IEC 62196 Type 2 or the US standard SAEJ1772.

The invention is described in more detail in the following with reference to the drawings on the basis of preferred exemplary embodiments.

In the drawings:

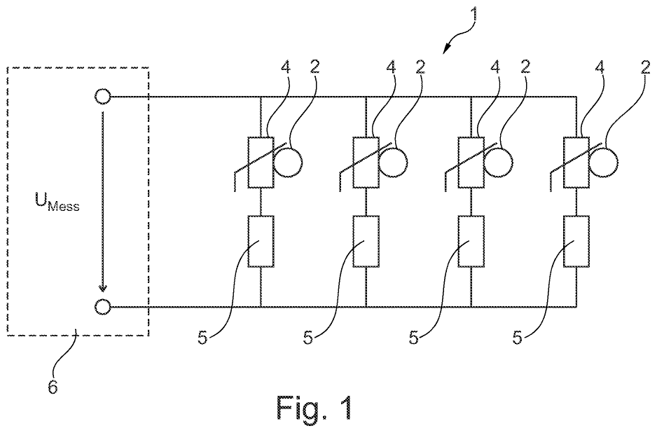

FIG. 1 schematically shows an electric circuit according to a first preferred exemplary embodiment of the invention,

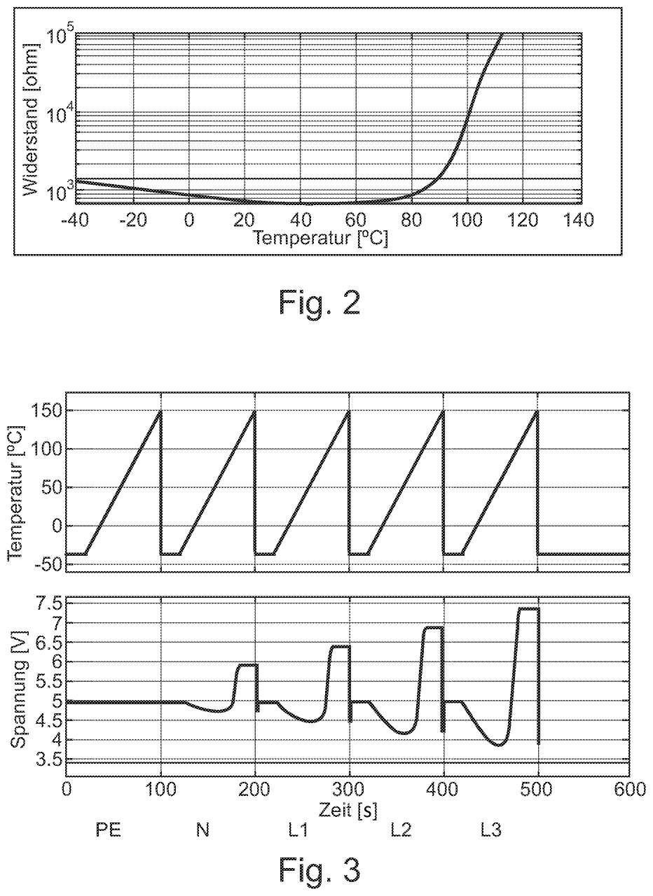

FIG. 2 shows the temperature-based resistance behavior of a PTC element as a temperature-based resistor in the circuit according to FIG. 1,

FIG. 3 shows the temperature-based curve of the measuring voltage in the circuit shown in FIG. 1 for the various AC charging contacts of a charging plug connector when using the circuit from FIG. 1,

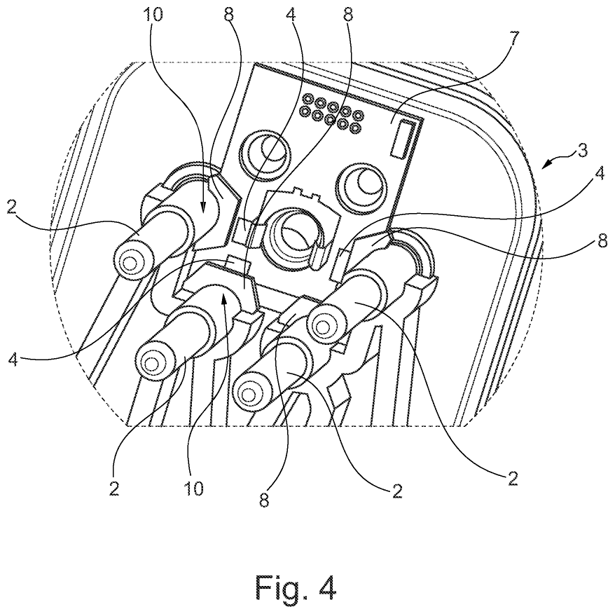

FIG. 4 shows a charging plug connector with an electric circuit board carrying the electric circuit shown in FIG. 1,

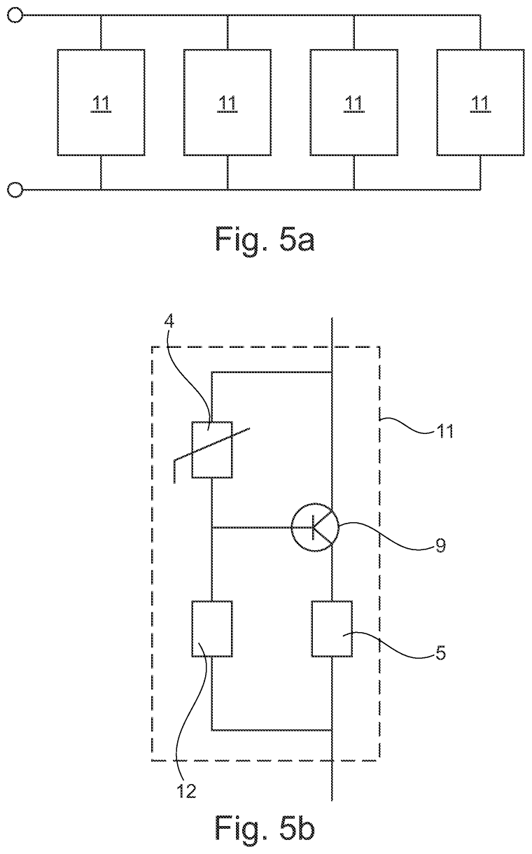

FIG. 5a schematically shows an electric circuit according to a second preferred exemplary embodiment of the invention, and

FIG. 5b shows the individual interconnections of the electric circuit from FIG. 5a in detail.

FIG. 1 shows schematically an electric circuit 1 according to a preferred exemplary embodiment of the invention. Not part of the electric circuit 1, but already shown in FIG. 1, are charging contacts 2 of a charging plug connector for an electric or hybrid vehicle, the corresponding temperature of which is to be monitored.

The electric circuit 1 according to the preferred exemplary embodiment of the invention described here has temperature-based resistors 4 and constant resistors 5. A temperature-based resistor 4 is connected in series with a constant resistor 5. The explanation of the preferred exemplary embodiment of the invention described here is based on a charging plug connector 3 shown in detail in FIG. 4 in the form of a built-in charging plug that can be installed in a body of an electric or hybrid vehicle in accordance with the European standard IEC 62196 Type 2. The charging contacts 2 shown in FIG. 1 are the AC contacts of the built-in charging plug 3, which are designated L1, L2, L3 and N according to this standard. In this respect, there are four charging contacts 2 of which the corresponding temperatures are to be monitored. Therefore, four pairs of a temperature-based resistor 4 and a constant resistor 5 are provided, each of which is connected in series with each other. These four series circuits are connected in parallel, wherein a voltage measuring device 6 is provided, by means of which the voltage dropping across the parallel circuit can be determined.

A key aspect is that the temperature-based resistors 4 are all made of the same type of PTC element, i.e. they all show the same temperature-based resistance behavior. In contrast, the constant resistors are all different from each other in that all constant resistors have different resistances.

In this case, the constant resistors have 5 different resistances, which follow the law of a diverging geometric row. Specifically, the resistances are 200 Ω, 400 Ω, 800Ω and 1600Ω. In this way, the resistances of the constant resistors 5 are not too close to each other, so that it is not a problem that, due to the temperature dependence of the temperature-based resistor 4, the resistance of a corresponding series circuit basically already fluctuates with the temperature before the trigger threshold of a corresponding PTC element is reached.

With regard to the temperature-based resistance behavior and the trigger threshold of the PTC elements, which are provided as temperature-based resistors 4, reference is made to FIG. 2. It shows how the resistance of the PTC elements used here changes depending on the temperature. It can be seen that the resistance of the PTC elements in the temperature range from −40 °C to 90 °C is between 618 and 1350Ω. Above 90 °C, the resistance of the PTC elements increases sharply, so that a resistance of approximately 10000Ω is already present at 100 °C. The trigger threshold here is therefore in a range above 1350 ohms.

This results in a resistance behavior of the parallel circuit shown in FIG. 1 of the corresponding pairs of a temperature-based resistor 4 and a constant resistor 5, which is described by means of the measuring voltage U_{Mess} which in turn was detected by means of the voltage measuring device 6. The resistance behavior is shown in FIG. 3.

FIG. 3 shows in its upper region the temperature which was first applied to the charging contact 2, designated PE in accordance with this standard, and subsequently to the charging contacts N1, L1, L2 and L3. Since there is no temperature-based resistance or constant resistance at the charging contact designated PE, the temperature dependence does not lead to any change in the voltage detected by means of the voltage measuring device 6. However, the charging contacts 2 with the designations N, L1, L2 and L3 are each provided with a pair formed of a temperature-based resistor 4 and a constant resistor 5. Due to the temperature-based resistance characteristic of the temperature-based resistors 4 shown in FIG. 2, a curve of the total resistance of the electric circuit 1 shown in FIG. 1 is obtained, which leads to the voltage curves shown in FIG. 3.

In terms of shape, the various voltage curves at the charging contacts 2, designated N, L1, L2 and L3, are all qualitatively the same when the temperature increases. However, due to the different resistances of the corresponding constant resistors 5, quantitatively different voltages arise on the way to the trigger threshold of the corresponding PTC element. Specifically, the trigger threshold is reached for the charging contact 2 designated N when the voltage measuring device 6 measures a value of approximately 6 V. This voltage value increases successively for the voltage contacts 2 with the designations L1, L2 and L3 to approximately 6.4 V, 6.8 V and 7.2 V. In this way, each resistance path that is paired with a corresponding charging contact 2 is virtually “coded,” since the resulting total resistance of the circuit 1, which in turn is based on the measuring voltage U_{Mess}, can be used to determine which charging contact 2 has experienced a temperature increase responsible for the change in the total resistance of the electric circuit 1.

Furthermore, reference is again made to FIG. 4, which shows a built-in charging plug 1 according to the European standard IEC 62196 Type 2 in detail. From FIG. 4, it can be seen that an electric circuit board 7, on which the temperature-based resistors 4 are arranged, is inserted practically “between” the charging contacts 2 of the built-in charging plug 3. For the sake of clarity, the constant resistors 5 are not shown here. The temperature-based resistors are coupled to thermal contact elements 8, which are located in corresponding part-circular cutouts 10 of the circuit board 7. These thermal contact elements 8 thus contact a corresponding charging contact 2 directly, so that a very good heat exchange between the corresponding charging contact 2 and the corresponding temperature-based resistor 4 can be achieved. In this way, the corresponding temperature of a charging contact 2 can be determined almost in real time using the temperature-based resistors 4. By additionally providing the electric circuit 1 shown in FIG. 1, which is also not shown in FIG. 4 for the sake of clarity, it can be determined, as previously described, exactly at which charging contact 2 the temperature increase occurred that led to a change in the measuring voltage U_{Mess} measured by the voltage measuring device 6.

FIG. 5a now schematically shows an electric circuit according to a second preferred exemplary embodiment of the invention. Four interconnections 11 are connected in parallel, wherein the individual interconnections 11 are constructed as shown schematically in FIG. 5b:

Each interconnection 11 has a transistor 8, wherein a temperature-based resistor 4 is connected to the base of a corresponding transistor 8. In addition, a constant resistor 5 is connected in series with a transistor 8 via its two other terminals. All of the constant resistors 5 have different fixed resistances and each constant resistor 5 is connected with its end facing away from the corresponding transistor 8 to the corresponding temperature-based resistor 4 via a corresponding auxiliary constant resistor 12.

The second preferred exemplary embodiment of the invention now offers two options: If the temperature-based resistors 4 are each a PTC element, the PTC element becomes highly resistive when a predefined limit temperature is reached at the charging contact, which causes a voltage drop at the transistor base, so that the transistor 8 blocks. However, if an NTC element is used when the limit temperature at the charging contact is reached, the NTC element becomes low-resistance, which causes a voltage increase at the transistor base, causing the transistor 8 to switch on. This allows a corresponding electrical path to be virtually “switched on” or “switched off” by means of the corresponding transistor 8, so that the corresponding change in the total resistance of the electric circuit can be used to determine the charging contact at which the limit temperature has been exceeded.

### LIST OF REFERENCE SIGNS

1 electric circuit
2 charging contacts
3 charging plug connector/built-in charging plug
4 temperature-based resistors
5 constant resistors
6 voltage measuring device
7 electric circuit board
8 thermal contact elements
9 transistors
10 recesses
11 interconnection
12 auxiliary constant resistors

1. An electric circuit for monitoring the corresponding temperature of a plurality of charging contacts of a charging plug connector for an electric or hybrid vehicle, the electric circuit comprising:
a plurality of temperature-based resistors, each of which is paired with a charging contact of the plurality of charging contacts and is thermally coupled to the charging contact, and
a plurality of constant resistors, each of which has a constant resistance,
wherein each temperature-based resistor is connected to one of the plurality of constant resistors,
a parallel circuit comprising interconnections of a corresponding temperature-based resistor and a corresponding constant resistor that are connected together in parallel,
wherein the plurality of constant resistors have different resistances, and
a voltage measuring device, wherein the voltage measuring device is configured to measure a voltage dropping across the parallel circuit.

2. The electric circuit according to claim 1, wherein
each of the temperature-based resistors is connected to one of the constant resistors in series, and
the parallel circuit comprises series circuits including a corresponding temperature-based resistor and a corresponding constant resistor that are connected together in parallel.

3. The electric circuit according to claim 1 further comprising a plurality of transistors,
wherein the interconnections are provided according to which a temperature-based resistor is connected to a base of a corresponding transistor and the constant resistors are connected in series with a corresponding transistor via two other terminals of the corresponding transistor, and
the parallel circuit comprises the interconnections each including a constant resistor, a transistor and a temperature-based resistor that are connected together in parallel.

4. The electric circuit according to claim 1, wherein the temperature-based resistors are all of a same type and have a same dependence of resistance on temperature.

5. The electric circuit according to claim 1, wherein a resistance of the constant resistor with a second lowest resistance is at least twice as high as a resistance of the constant resistor with a lowest resistance.

6. The electric circuit according to claim 5, wherein a difference between any two resistances of all constant resistors is at least as large as a difference between the resistance of the constant resistor with the second lowest resistance and the resistance of the constant resistor with the lowest resistance.

7. The electric circuit according to claim 5, wherein, except for the constant resistor with the lowest resistance, the resistance of each constant resistor is at least twice the resistance of the constant resistor with a next smallest resistance.

8. The electric circuit according to claim 5, wherein the resistances of the constant resistors follow the law of a diverging geometric series.

9. The electric circuit according to claim 8, wherein, for the resistances R₁, . . . , Rₙ of the constant resistors, the following formula applies
$${R}_{1} {\sum }_{k = 0}^{n} {q}^{k} = \{ {R}_{1} , ... , {R}_{n} \}$$
wherein
R₁ constitutes the resistances of the constant resistor with the lowest resistance,
Rₙ constitutes the resistances of the constant resistor with the highest resistance and
q is any value greater than 1.

10. An electric circuit board for installation in a charging plug connector for an electric or hybrid vehicle, with an electric circuit according to claim 1.

11. The electric circuit board according to claim 10,
wherein electric circuit board includes thermal contact points,
wherein the charging plug connector includes a charging contact, and
wherein the temperature-based resistors are arranged at the thermal contact points of the electric circuit board for thermally contacting a corresponding charging contact of the charging plug connector, and the thermal contact points are provided with thermal contact elements which are in direct thermal contact with a corresponding temperature-based resistor and with which the charging contacts can be physically contacted.

12. The electric circuit board according to claim 11, wherein the thermal contact points are formed by recesses in the electric circuit board.

13. A charging plug connector for an electric or hybrid vehicle with an electric circuit according to claim 1.

14. The charging plug connector according to claim 13, wherein the temperature-based resistors are arranged in such a way that the temperature-based resistors are used to detect the corresponding temperature of an AC charging contact.

15. The charging plug connector according to claim 13, wherein the charging plug connector is designed as a built-in charging plug that is installed in the body of an electric or hybrid vehicle.

16. A charging plug connector for an electric or hybrid vehicle with an electric circuit board according to claim 10.
